(19) United States
(12) Patent Application Publication
(10) Pub. No.: US 2026/0167562 A1
(43) Pub. Date: Jun. 18, 2026

(54) COATED INORGANIC FILAMENTS AND THEIR PREPARATION

(71) Applicant: SABIC GLOBAL TECHNOLOGIES B.V., Bergen op Zoom (NL)

(72) Inventors: Gert Boven, Steenbergen (NL); Gerard Jan Eduard Biemond, Brunssum (NL); Robert Russell Gallucci, Mt. Vernon, IN (US); Robert Maria Martin Donners, Brunssum (NL); Maria Soliman, Selfkant (DE); Robbert Duchateau, Roostenlaan (NL); Nikhil K. E. Verghese, Richmond, TX (US); Shawn Lim, Aachen (DE); Philipp Klaus Werner Picard, Aachen (DE); Pramod Ravichandran, Aachen (DE); Richard Haas, Aachen (DE); Alexander Luking, Aachen (DE); Robert Brull, Würselen (DE)

(21) Appl. No.: 19/125,850

(22) PCT Filed: Oct. 30, 2023
(86) PCT No.: PCT/EP2023/080232

§ 371 Date: Apr. 30, 2025

(30) Foreign Application Priority Data
Oct. 31, 2022 (EP) 22204760.7
Oct. 31, 2022 (EP) 22204761.5
Dec. 20, 2022 (EP) 22215133.4

(51) Int. Cl. C03C 25/30; C09D 151/00

(52) U.S. Cl. CPC C03C 25/30; C09D 151/003

(57) ABSTRACT

A coated filament including an inorganic filament and a polymer composition including a thermoplastic polymer, wherein the polymer composition is in direct contact with the filament and wherein the coated filament has a length of less than 100 mm.

### BACKGROUND

There are various processes for producing inorganic fibers coated with organic material as substrate, such as dip coating processes, pre-dosed coating processes, or curtain coating processes.

In the pre-dosed coating process, the liquid used for coating is squeezed between the nozzle and the substrate. This leads to shear forces acting on the substrate. In the inline coating of filaments, this leads to filament breakage at high speeds.

In curtain coating, the direction of the liquid flow and the movement of the fibers are not coordinated. This results in an immediate change in the direction of flow of the liquid used for coating. The result is high Reynolds numbers and thus turbulent flow. This turbulent flow is not matched to the movement of the filaments and cannot be controlled resulting in droplet formation in the liquid and air entrainment at the contact point.

The same applies to dip coating.

Therefore, the present invention is based on the task of remedying the above-mentioned problems.

### SUMMARY

The invention is defined by the subject matter of the appended claims.

Disclosed is a coated filament comprising an inorganic filament and a polymer composition comprising a thermoplastic polymer, wherein the polymer composition is in direct contact with the filament and wherein the coated filament has a length of less than 100 mm. Since the polymer composition is in direct contact with the filament, this means that there are no components present between the surface of the inorganic filament and the coating layer, so this means that there are no adhesion promoters, sizings or similar compounds between the polymer composition and the inorganic filament. Typically, adhesion promoters or sizings are first applied to the inorganic filament before coating with a polymer composition.

The process described below eliminates the need for coatings with adhesion promoters or the like between the inorganic filament and the polymer composition.

The inorganic filament can be a mineral material, e.g., engineering glasses (electrical glasses (E glasses, alumino-borosilicate glasses with less than 1 wt % alkali oxides); A glasses (alkali-lime glasses with little to no boron oxide); AR glasses; electrical/chemical resistance glasses (E-CR glasses, alumino-lime-silicate glasses with less than 1 wt. % alkali oxides and with high acid resistance); C glasses (alkali-lime glasses with high boron oxide content, also T glasses); D glasses (borosilicate glasses with low dielectric constant); R glasses (aluminosilicate glasses without MgO and CaO); S glasses (aluminosilicate glasses without CaO but with high MgO content); M glasses; or basalt; kaolin; alkaline earth silicate (AES, combination of CaO, MgO and SiO₂); refractory ceramic fibers (RCF, also aluminosilicate, ASW); polycrystalline wool (PCW, contains over 70% alumina); alumina; metallic materials (steel alloys; aluminum alloys; copper alloys, platinum alloys and pure platinum, especially alloys with rhodium).

Preferred inorganic filaments are glass fibers, E glasses, or E-CR glasses.

The polymer composition comprises a thermoplastic polymer, for example in an amount of at least 95 wt %, for example in an amount of at least 96 wt, preferably in an amount of at least 97 wt %, for example in an amount of at least 98.5 wt % based on the polymer composition and may optionally contain additives, for example in an amount from 0.1 to 5.0 wt % based on the polymer composition.

Preferably, the polymer composition comprises at least 95 wt %, for example in an amount of at least 96 wt, preferably in an amount of at least 97 wt %, for example in an amount of at least 98.5 wt % of the thermoplastic polymer based on the polymer composition and/or wherein the thermoplastic polymer is chosen from the group of acrylonitrile butadiene styrene (ABS), acrylonitrile styrene acrylate (ASA), polyethylene (PE), polyolefin elastomer (POE), polyethylene terephthalate (PET), polypropylene (PP), polyvinylchloride (PVC), polybutadiene (BR), ethylene propylene diene monomer (EPDM, polyamide (PA), thermoplastic polyurethane (TPU) and mixtures thereof, preferably wherein the thermoplastic polymer is a polypropylene.

The thermoplastic polymer may be selected from the group consisting of: Polymers soluble in trichloromethane, tetrachloromethane or 1-bromonaphthalene such as acrylic polymers (acrylonitrile-butadiene-styrenes (ABS), acrylonitrile-styrene-acrylates (ASA), polyisobutyl methacrylates (PiBMA), poly-n-butyl methacrylates (PnBMA), polyethyl methacrylate (PEMA), polymethyl methacrylates (PMMA)), cellulose acetate butyrates (CAB), fluorinated ethylene polypropylenes (FEP), polyamides (PA) such as polyamide 12 (PA-12), polybutadienes, polycarbonates (PC) such as bisphenol A polycarbonates, polychlorotrifluoroethylene (PCTFE), polyimides such as polyetherimides (PEI), polysulfones such as polyethersulfones (PES), polyethylenes (PE) such as UHMWPE, HMWPE, HDPE, LLDPE, LDPE, Polyethylene terephthalates (PET), polyisobutylenes (PiB, butyl rubber), polyisoprenes (PiP), polylactic acids (PLA), polyphenylene oxides (PPO), polyphenylene sulfides (PPS), Polypropylenes (PP), atactic PP, isotactic PP, polystyrenes (PS), polysulfones (PSU), polyurethanes (PU), polyvinyl acetates (PVA), polyvinyl butyrals, Polyvinyl chlorides (PVC), bromosoluble polymers, acrylic polymers, polyethyl methacrylates (PEMA), polymethyl methacrylates (PMMA), cellulose acetates (CA), cellulose acetate butyrates (CAThB), nitrocelluloses (cellulose nitrates), polycarbonates (PC), bisphenol A polycarbonates, polyphenylene oxides (PPO), polyurethanes (PU), polyvinyl acetates (PVA).

The composition can comprise A) a grafted polypropylene grafted with C1) a side chain compound capable of forming hydrogen bond and/or
B) a non-grafted polypropylene and C2) a compound capable of forming hydrogen bond, wherein the total amount of A) and B) with respect to the polypropylene composition is at least 70 wt % and the polypropylene composition comprises D) a low molecular weight polyethylene, for example a low molecular weight polyolefin having molecular weight of at most 5000 g/mol in an amount of less than 10 wt % with respect to the polypropylene composition.

The use of an adhesion promoter, preferably a side chain compound capable of forming hydrogen bond or/and a compound capable of forming hydrogen bond in the polymer composition improves the adhesion between the polymer composition and the inorganic fiber. Surprisingly, it was found that it is possible to produce coated filaments in which the adhesion promoter is contained in the polymer composition itself rather than as an interlayer. This simplifies the production process.

The coated glass filament may be in the form of a single glass filament provided with a coating layer. In this case, the coating layer can be provided over substantially the whole or part of the surface of the glass filament. The coated glass filament may be in the form of a plurality of glass filaments which are (partly) bundled together. In this case, the coating layer may not be present on the parts of the glass filaments in contact with each other.

In some preferred embodiments, the glass filament on which the coating layer is provided has been obtained by recycling a polymer coated glass filament, such as an epoxy coated chopped glass filament. The polymer such as epoxy can be removed from the polymer coated glass filament, for example by burning off the polymer, to obtain a non-coated glass filament. A coating of a polypropylene composition can be provided directly on the non-coated glass filament so obtained to obtain the coated glass filament. The use of recycled materials is highly desirable in view of the increase in the sustainability awareness.

The coated glass filament comprises a coating layer of polymer composition, preferably a polypropylene composition provided directly on the glass filament. Due to the absence of sizing composition, problems associated with sizing composition are solved.

Preferably, the polypropylene composition used comprises C1) a side chain compound capable of forming hydrogen bond (as part of the grafted polypropylene) and/or C2) a compound capable of forming hydrogen bond. The presence of C1) and/or C2) in the polypropylene composition improves adhesion to glass fibers. The compounds C1) and C2) have a hydrogen atom or have a functional group which generates a hydrogen atom by (partial) hydrolyzation of the group, which is capable of forming hydrogen bond with the glass filaments. The hydrogen bond improves adhesion of the polypropylene composition to the glass filaments. In some cases, in addition to forming hydrogen bond, condensation reactions between silanol groups on the glass surface and the hydrogen atom can create an ester or ether linkage and thus result in a covalent bond to the glass surface.

Preferably, the polypropylene composition comprises
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof;
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof and B) a non-grafted polypropylene;
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof,
B) a non-grafted polypropylene and C2) a compound selected from oligosilanes (e.g. vinyl-oligosilane, aminopropyl-oligosilane, acryloxy-oligosilane), a copolymer of ethylene and 2-hydroxyethyl methacrylate, epoxy (meth)acrylates, polyamides, an organometallic compound having a pyrophosphate group and combinations thereof; or
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof,
B) a non-grafted polypropylene and
C2) a compound selected from vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

### A) Grafted Polypropylene

The polypropylene composition used may comprise a grafted polypropylene. The grafted polypropylene is a polypropylene grafted with C1) a side chain compound capable of forming hydrogen bond.

Suitable examples of C1) include anhydrides (e.g. maleic anhydride, itaconic anhydride), oligosilanes (e.g. vinyl-oligosilane, aminopropyl-oligosilane, acryloxy-oligosilane), epoxy (meth)acrylates, polyamides, and combinations thereof. The skilled person knows how to obtain A) by grafting C1) to polypropylene. When C1) is maleic anhydride, the double bond of maleic anhydride is consumed to achieve grafting and succinic anhydride linkages to the polypropylene are made. An example of epoxy (meth)acrylates is glycidyl methacrylate.

Preferably, C1) comprises anhydrides (e.g. maleic anhydride, itaconic anhydride). Most preferably, C1) comprises maleic anhydride. This result in a good adhesion between the polypropylene composition and the glass filaments. Preferably, C2) has an unsaturated group which can react with the non-grafted polypropylene to form the hydrogen bond or C2) has a hydrophobic group (e.g. copolymer of ethylene and 2-hydroxyethyl methacrylate (PE-HEMA).

Preferably, the amount of C1) with respect to the amount of A) is 0.5 to 10 wt %, for example 0.6 to 5.0 wt %, 0.7 to 3.0 wt %, 0.8 to 2.0 wt %.

### C2) Compound Capable of Forming Hydrogen Bond

The polypropylene composition used may comprise B) a non-grafted polypropylene and C2) a compound capable of forming hydrogen bond.

Suitable examples of C2) include oligosilanes (e.g. vinyl-oligosilane, aminopropyl-oligosilane, acryloxy-oligosilane), a copolymer of ethylene and 2-hydroxyethyl methacrylate (PE-HEMA), epoxies, polyamides, an organometallic compound having a pyrophosphate group and combinations thereof.

When the polypropylene composition comprises A), C2) is preferably a compound selected from oligosilanes (e.g. vinyl-oligosilane, aminopropyl-oligosilane, acryloxy-oligosilane), a copolymer of ethylene and 2-hydroxyethyl methacrylate (PE-HEMA), epoxy (meth)acrylates, polyamides, an organometallic compound having a pyrophosphate group and combinations thereof.

When the polypropylene composition does not comprise A), C2) is preferably a compound selected from vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

Preferably, C2) is selected from the group consisting of oligosilanes (e.g. vinyl-oligosilane, aminopropyl-oligosilane, acryloxy-oligosilane), an organometallic compound having a pyrophosphate group and combinations thereof. This result in a good adhesion between the polypropylene composition and the glass filaments.

Preferably, C2) comprises a vinyl-oligosilane or an acryloxy-oligosilane, more preferably a vinyl-oligosilane. This result in a particularly good adhesion between the polypropylene composition and the glass filaments.

Oligosilanes were found to have volatility which is low enough to react with polypropylene to achieve the desired effect.

Preferably, the polypropylene composition is free of or is substantially free of an alkoxysilane compound having molecular weight of less than 300 (e.g. γ-aminopropyltriethoxysilane (APTES), γ-glycidoxypropyltrimethoxysilane (GPTMS), γ-methacryloxypropyltrimethoxysilane (MPTMS), vinyltriethoxysilane (VTES)). Preferably, the amount of such alkoxysilane compound having molecular weight of less than 300 with respect to the polypropylene composition is less than 10 wt %, less than 5.0 wt %, less than 3.0 wt %, less than 1.0 wt %, less than 0.5 wt % or 0 wt %.

Preferably, C2) comprises an organometallic compound having a pyrophosphate group, preferably a titanate pyrophosphate compound or a zirconate pyrophosphate compound. This result in a particularly good adhesion between the polypropylene composition and the glass filaments. Suitable examples include neopentyl(diallyl) oxy tri (dioctyl) pyrophosphato titanate, cyclo(dioctyl) pyrophosphate dioctyl titanate, dicyclo(dioctyl) pyrophosphate titanate, neopentyl(diallyl) oxy tri (N-ethylenediamineo)ethyl titanate, cyclo [dineopentyl(diallyl)]pyrophosphato dineopentyl(diallyl) zirconate, di(dioctyl) pyrophosphate oxoethylene titanate and the 2-(N,N-dimethylamino) isobutanol adduct of di(dioctyl) pyrophosphate oxoethylene titanate.

Preferably, the amount of C2) with respect to the total amount of B) and C2) is 0.2 to 10 wt %, for example 0.3 to 5.0 wt %, 0.4 to 3.0 wt %, 0.5 to 2.0 wt %.

### D) Low Molecular Weight Polyolefin

The polypropylene composition comprises D) a low molecular weight polyethylene having number average molecular weight of at most 5000 g/mol in an amount of less than 10 wt % with respect to the polypropylene composition. It will be appreciated that this includes the situation where the polypropylene composition does not comprise D) a low molecular weight polyethylene having number average molecular weight of at most 5000 g/mol. If the polypropylene composition comprises D) a low molecular weight polyethylene having number average molecular weight of at most 5000 g/mol, its amount with respect to the polypropylene composition is less than 10 wt %. Accordingly, this feature may also be expressed as “the amount of D) a low molecular weight polyethylene having number average molecular weight of at most 5000 g/mol in the polypropylene composition is less than 10 wt % with respect to the polypropylene composition”.

Preferably, the polypropylene composition is free of or is substantially free of a low molecular weight polyethylene having a number average molecular weight of at most 5000 g/mol. Preferably, the amount of such low molecular weight polyethylene with respect to the polypropylene composition is less than 10 wt %, less than 5.0 wt %, less than 3.0 wt %, less than 1.0 wt %, less than 0.5 wt % or 0 wt %.

Preferably, the polypropylene composition is free of or is substantially free of a low molecular weight polyolefin having number average molecular weight of at most 5000 g/mol. For example, the amount of such low molecular weight polyolefin (total of low molecular weight polyethylene having number average molecular weight of at most 5000 g/mol and any other polyolefins having number average molecular weight of at most 5000 g/mol) with respect to the polypropylene composition is less than 10 wt %, less than 8.0 wt %, less than 5.0 wt %, less than 3.0 wt %, less than 1.0 wt %, less than 0.5 wt % or 0 wt %.

### Additives

The polymer composition, such as the polypropylene composition may further comprise additives, such as for example flame retardants, pigments, lubricants, slip agents flow promoters, antistatic agents, processing stabilizers, long term stabilisers and/or UV stabilizers. The amount of the additives may e.g. be 0.1 to 5.0 wt %.

Preferably, the total amount of A), B), C2), D) and the additives is 100 wt % with respect to the polypropylene composition.

### Preferred Compositions

Preferably, the polypropylene composition has a melt viscosity of at most 25 Pa·s, preferably in the range from 1.0 to 25 Pa·s, more preferably in the range from 1.0 to 20 Pa·s, even more preferably in the range from 1.8 to 19.4 Pas or in the range from 1.0 to 15 Pa·s, even more preferably in the range from 1.0 to 10 Pa·s, most preferably 1.0 to 5.0 Pa·s at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%. In some preferred embodiments, the amount of A) with respect to the polypropylene composition in an amount of at least 50 wt %, at least 60 wt %, at least 70 wt %, at least 80 wt %, at least 90 wt %, at least 95 wt %, at least 98 wt %, at least 99 wt % or 100 wt %.

In some preferred embodiments, the total amount of B) and C2) with respect to the polypropylene composition in an amount of at least 50 wt %, at least 60 wt %, at least 70 wt %, at least 80 wt %, at least 90 wt %, at least 95 wt %, at least 98 wt %, at least 99 wt % or 100 wt %.

In some preferred embodiments, the polypropylene composition comprises A) and B). Preferably, the total amount of A) and B) with respect to the polypropylene composition is at least 70 wt %, at least 80 wt %, at least 90 wt %, at least 93 wt %, at least 95 wt %, at least 97 wt %, at least 99 wt % or 100 wt %. Preferably, the amount of A) with respect to the total amount of A) and B) is 1.0 to 30 wt %, for example 2.0 to 25 wt %, 3.0 to 20 wt % or 4.0 to 10 wt %.

In some preferred embodiments, the polypropylene composition comprises A), B) and C2). Preferably, the amount of B) with respect to the total amount of A), B) and C2) is at least 65 wt %. Preferably, the amount of A) with respect to the total amount of A) and B) is 1.0 to 30 wt %, for example 2.0 to 25 wt %, 3.0 to 20 wt % or 4.0 to 10 wt %. Preferably, the amount of C2) with respect to the total amount of B) and C2) is 0.2 to 10 wt %, for example 0.3 to 5.0 wt %, 0.4 to 3.0 wt %, 0.5 to 2.0 wt %. In particularly preferred embodiments, the amount of A) is 1.0 to 5.0 wt %, the amount of B) is 90 to 98 wt %, the amount of C) is 1.0 to 5.0 wt %, with respect to the total amount of A), B) and C).

In particularly preferred embodiments where the polypropylene composition comprises A), B) and C2), C1) is selected from the group consisting of anhydrides (e.g. maleic anhydride, itaconic anhydride) and C2) comprises an organometallic compound having a pyrophosphate group, preferably a titanate pyrophosphate compound or a zirconate pyrophosphate compound.

### Further Aspects

The invention further provides a multifilament strand comprising a plurality of the coated glass filaments which are bundled. The multifilament strand may further comprise non-coated glass filaments, but preferably at least 50 wt %, at least 60 wt %, at least 70 wt %, at least 80 wt %, at least 90 wt %, at least 95 wt %, at least 98 wt %, at least 99 wt % of the multifilament strand is the coated glass filaments.

The polymer composition can have a melt viscosity in the range from 1.0 to 25 Pas, for example in the range from 1.8 to 19.4 Pas at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%.

Preferably, the polymer composition meets inequation 1:

$$η \leq ( 82 \times e \hat{} 0.007 \times ( ACTO ) ) + \_ 5 \qquad ( inequation 1 )$$

wherein η stands for the melt viscosity in Pa·s as measured at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5% and wherein ACTO stands for the amount of active oxygen in the polymer composition in ppm.

The active oxygen content of the formulations is calculated based on the concentration of peroxide and the active oxygen content of the peroxide as can be found in the technical data sheet of the supplier.

The polymer composition can be applied to glass filaments in a molten state. At the application temperature (for example 250° C. or 290° C.), the melt viscosity of the polymer composition should not be too high.

Preferably, the polymer composition, for example the polypropylene composition has a melt viscosity of at most 25 Pa·s, preferably in the range from 1.0 to 25 Pa·s, more preferably in the range from 1.0 to 20 Pa·s, even more preferably in the range from 1.8 to 19.4 Pas or in the range from 1.0 to 15 Pa·s, even more preferably in the range from 1.0 to 10 Pa·s, most preferably 1.0 to 5.0 Pa·s at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%.

The polypropylene composition can be obtained by i) polymerizing monomers to obtain an intermediate polypropylene and ii) visbreaking said intermediate polypropylene.

For example, the intermediate polypropylene can have a melt flow index according to ISO1133-1:2011 at 230° C. and 2.16 kg of 1.0 to 100 dg/min.

Visbreaking may be performed by melt-mixing the intermediate polypropylene and at least one of a peroxide, a hydroxylamine ester and a sulphur compound.

Preferably, the melt-mixing is performed at temperatures in the range of 160 to 300° C. When the melt-mixing is performed in the presence of a peroxide, the melt-mixing is preferably performed at temperatures of 200 to 300° C., for example 220 to 280° C. or 240 to 260° C. When the melt-mixing is performed in the presence of a hydroxylamine ester, the melt-mixing is preferably performed at temperatures in the range of 280 to 300° C.

When the visbreaking is performed in the presence of a peroxide, the melt-mixing is performed for a period of time at least 3 times, for example 4 to 7 times or 5 to 6.5 times the half-life of the organic peroxide at the temperature of the melt mixing.

Preferably, the amount of the peroxide in the visbreaking step ii) is selected such that the polypropylene composition contains active oxygen at a concentration of at least 200 ppm, preferably 200 to 1000 ppm, with respect to the polypropylene composition.

Preferably, the amount of the peroxide in the visbreaking step ii) is selected such that the polypropylene composition contains active oxygen at a concentration of at least 300 ppm, preferably at least 400 ppm, more preferably at least 525 ppm, with respect to the polypropylene composition.

In some embodiments, the peroxide comprises a first peroxide having a half-life time of 1 hour at a first temperature T_{1/2}1 of 120 to 145° C., preferably 125 to 140° C., more preferably 128 to 137° C. Examples of the first peroxide include 2,5-Dimethyl-2,5-di(tert-butylperoxy) hexane (e.g. Trigonox™ 101 manufactured by AkzoNobel), which has T_{1/2}1 of 134° C.

Preferably, the first peroxide has a half-life time of 0.1 hour at a temperature of 140 to 180° C., more preferably 150 to 170° C.

In some embodiments, the peroxide comprises a second peroxide having a half-life time of 1 hour at a second temperature T_{1/2} of higher than 145° C. and at most 180° C., preferably at most 170° C., for example higher than 145° C. and at most 150° C. or at least 155° C. and at most 170° C.

Further, the second peroxide preferably has a half-life time of 0.1 hour at a temperature of 165 to 188° C. Examples of the second peroxide include 3,6,9-Triethyl-3,6,9-trimethyl-1,4,6 triperoxonane (e.g. Trigonox™ 301 manufactured by Nouryon), which has T_{1/2}2 of 146° C. and a half-life time of 0.1 hour at a temperature of 170° C. and 3,3,5,7,7-pentamethyl-1,2,4-trioxepane (e.g. Trigonox™ 311 manufactured by Nouryon), which has T_{1/2}2 of 166° C. and a half-life time of 0.1 hour at a temperature of 185° C.

In some embodiments, the peroxide is the first peroxide or the second peroxide.

In some embodiments, the peroxide comprises the first peroxide and the second peroxide.

Preferably, the amount of the peroxide with respect to the intermediate polypropylene is 100 to 10000 ppm.

Preferably, the amount of the first peroxide with respect to the intermediate polypropylene is 100 to 2000 ppm.

Preferably, the amount of the second peroxide with respect to the intermediate polypropylene is 100 to 8000 ppm, preferably 1000 to 8000 ppm.

Preferably, the sulphur compound has the formula R₁—S—H, wherein R₁ represents C8-C18alkyl.

A polymer composition with the specified viscosity can be used particularly efficiently in coating the inorganic filament at high speeds.

The coating with the polymer composition can be a speckle (spot) coating or mantle coating. In the case of a speckle coating, the coating does not completely envelop the filament but is distributed on the filament in the form of spaced speckles covering 1-90%, 5-90%, 10-90% of the surface of the fiber. In the case of mantle coating, the coating substantially completely encapsulates the filament covering more than 90% of the surface of the fiber. The filament of the coated filament may have a diameter in the range of >2 μm to <50 μm and/or the polymer composition layer may have a thickness in the range of >0.5 μm to <5 μm.

The filament of the coated filament may have a diameter in the range of >3 μm to <30 μm, preferably in the range of >8 μm to <10 μm. The polymer composition layer may have a thickness in the range of >0.02 μm to <3 μm, >0.1 μm to <3 μm>0.2 μm to <3 μm, preferably in the range of >0.7 μm to <0.9 μm. Fibers (filament bundles) with variable diameters can be produced from several filaments.

Also disclosed is a filament bundle comprising a plurality of the coated filaments described above.

After coating with the polymer composition, the coated filaments may be immediately combined or spun into a filament bundle. Thus, the still fluid polymer composition can bind the filaments together. The bond within the filament bundle is thus particularly stable and can be further improved by the adhesion promoter, preferably by the presence of a compound capable of forming a hydrogen bond in the polymer composition, especially in the case of speckle coating.

One filament bundle can contain 2-5000 coated filaments. Also disclosed is a filament bundle a so called yarn of the invention.

Also disclosed is method for producing a coated filament comprising the steps of
a. producing an uncoated inorganic filament from an inorganic melt, preferably an uncoated glass filament;
b. providing a molten polymer composition comprising a thermoplastic polymer;
c. applying the molten polymer composition to the uncoated inorganic filament, preferably using a roller die, curtain coater die or a slit die and allowing the molten polymer composition to solidify and
d. obtaining a coated filament comprising an inorganic filament which is coated with the polymer composition and wherein the inorganic filament is in direct contact with the polymer composition and
e1. cutting the coated filament into pieces having a length of 100 mm or longer, or
e2 bundling a plurality of said coated filaments into a filament bundle or a yarn and optionally cutting the filament bundle or yarn into pieces having a length of 100 mm or longer.

Also disclosed is a coated filament, filament bundle or tape obtainable by a method for producing a coated filament comprising the steps of
a. producing an uncoated inorganic filament from an inorganic melt, preferably an uncoated glass filament;
b. providing a molten polymer composition comprising a thermoplastic polymer;
c. applying the molten polymer composition to the uncoated inorganic filament, preferably by using a roller die, curtain coater die or a slit die and allowing the molten polymer composition to solidify and
d. obtaining a coated filament comprising an inorganic filament which is coated with the polymer composition and wherein the inorganic filament is in direct contact with the polymer composition and
e1. cutting the coated filament into pieces having a length of less than 100 mm or
e2 bundling a plurality of said coated filaments into a filamentbundle or a yarn and optionally cutting the filament bundle or yarn into pieces having a length of less than 100 mm or
f. bundling a plurality of said coated filaments into a filamentbundle or a yarn and
g. producing a tape from the filamentbundle or from the yarn to produce a tape having a thickness from 0.2 up to and including 2 mm, a width from 10 up to and including 500 mm and wherein the tape has a length/width ratio of above 10.

It was surprisingly found that very high production speeds are possible by applying the said process. In the process, the molten polymer composition can be dispensed in the direction of gravity. In the process, the inorganic melt and/or the uncoated inorganic filament can be dispensed in the direction of gravity.

Inorganic filaments are generally produced by drawing from an inorganic melt. In the nozzle drawing process, glass pellets are metered and melted in a nozzle box—the bushing. The melt emerges through the nozzles in the form of filaments and solidifies so that the individual filaments can be wound onto a drawing drum. For this purpose, the device can include a storage container, for example for glass pellets.

Downstream of the nozzles, for example glass fiber bushings, is the coating device from which the molten polymer composition is dispensed.

During application, the direction of the uncoated inorganic filament and the direction of the polymer composition relative to each other at the point of contact may be at an (absolute) angle of no more than 45°, 25°, 10°, 5°, 1° or 0°.

In other words the direction of the uncoated inorganic filament and the direction of the polymer composition are substantially parallel to each other.

The angle is measured from the point where the polymer composition first wets the filament toward the point where the polymer composition first passes contacts the filament (point of first application) directly. The leg of the angle is a straight line imagined through the filament and a directly opposite straight line on the surface of the polymer composition between the wetting point and the point of first contact.

By specifying the angle or the essentially parallelism, undesirable forces (warping forces, turbulence due to changes in direction of the polymer composition) are reduced so that rapid wetting of the filament can take place.

When applying the polymer composition to the uncoated inorganic filament, the speed at which the polymer composition is moved can be 50% to 110%, 95% to 105%, or 99% to 101% of the speed at which the inorganic filament is moved. Alternatively or additionally, the speed at which the inorganic filament is moved can be 500 to 3000 m/min, 1250 to 1750 m/min, or 1450 to 1550 m/min.

Also, by keeping the speed of the filament and polymer composition as equal as possible, the occurrence of undesirable forces (warping forces, turbulence due to changes in the direction of the polymer composition) can be reduced, allowing rapid wetting of the filament.

In particular, the combination of a low angle between the polymer composition and the filament at the point of application and (almost) the same speed of the dispensed polymer composition and filament enables very high production speeds.

The inorganic melt or/and the uncoated inorganic filament can be electrostatically charged during production. The polymer can also be electrostatically charged.

The electrostatic charge(s) can provide better adhesion of polymer to the uncoated inorganic filament and vice versa.

The coated filament can also receive further modifications after being coated with polymer composition. For example, an adhesion promoter, crosslinker, lubricant, or film image can be applied to the coated filament.

The polymer composition used in the method can be provided by mixing a thermoplastic polymer comprising an adhesion promoter (e.g. grafted polymer) and a thermoplastic polymer not comprising an adhesion promoter (e.g. non grafted polymer). The thermoplastic polymers may be provided in solid or fluid form and then mixed, resulting in dry or wet blending, respectively. The solid polymer composition(s) may be provided as pellets.

In this way, the ratio of thermoplastic polymer comprising an adhesion promoter and a thermoplastic polymer not comprising an adhesion promoter can be suitably adapted. The mixing of the polymer(s) can occur in an additional mixing device or an extruder.

After coating with the polymer composition, the coated filaments may be immediately combined or spun into a filament bundle. Thus, the still fluid polymer composition can bind the filaments together. The bond within the filament bundle is thus particularly stable and can be further improved by the presence adhesion promoter in the polymer composition, especially in the case of speckle coating.

Also disclosed is a coating apparatus for producing a coated filament from an uncoated in-organic filament according to the above-described comprising:
a. a heating device for the production of fluid polymer composition, for example a molten polymer composition comprising a thermoplastic polymer;
b. a nozzle is arranged to discharge the fluid polymer composition obtained from the heater in the direction of gravity and arranged so that the fluid polymer composition meets an uncoated inorganic filament at an application point and starts to wet the uncoated inorganic filament at a wetting point;
c. a supply line between the heater and the nozzle;
d. the nozzle is set up in such a way that the angle alpha between the application point and the point of the start of wetting, the legs of which are a straight imaginary line through the filament, and a straight imaginary line through the surface of the polymer directly opposite the filament is between 0° and 45°, 0° and 25°, 0° and 10°, or 0° and 1°.

In other words the direction of the uncoated inorganic filament and the direction of the polymer composition are substantially parallel to each other.

For purpose of this application, the wording ‘die’ and nozzle are used interchangeably.

The coating apparatus can be set up to dispense the polymer composition via the nozzle under pressure. This can be achieved by an extruder, an additional pump or pressure vessel included in the device.

By specifying the angle or the essentially parallelism, undesirable forces (warping forces, turbulence due to changes in direction of the polymer composition) are reduced so that rapid wetting of the filament can take place.

The coating apparatus shall be arranged to dispense the molten polymer composition in the direction of gravity. The coating apparatus is arranged to dispense the inorganic melt and/or the uncoated inorganic filament in the direction of gravity.

The nozzle that is set up to dispense polymer composition can be a wide slot nozzle, a curtain coater, or a roll coater. The nozzle preferably allows molten polymer composition to be dispensed in a direction that is substantially parallel to the direction of the uncoated filament at the point of application.

A wide slot nozzle has a front face comprising the nozzle opening. The front face is a flat plane. Since the front face is a flat plane, the polymer composition after leaving the nozzle travels across the lower part of the flat plane driven by gravity. This lower part (and the upper part) of the front face is parallel to the fiber being guided through the coating apparatus.

A curtain coater also has a front face comprising the nozzle opening. The front face can be divided into an upper part above the nozzle opening and a lower part below the nozzle opening. The lower part is formed as lip.

The lower part is configured to allow the polymer composition to travel across the lower part of the flat plane after leaving the nozzle travels and driven by gravity. This lower part (lip part) of the front face is at an angle to the fiber being guided through the coating apparatus. The angle can be 5-45°, 10-40°, or around 30°. The upper part of the front face is parallel to the fiber being guided through the coating apparatus. Thus the upper part and the lip part of the curtain coater are at an angle of 5-45°, 10-40°, or around 30°.

It was surprisingly found that a curtain coater is especially useful since the application point is at the lower end of the front face. Thus, the polymer composition is not confined between the front face and the fiber for extended time or distance, thereby further reducing shear forces and other forces disturbing the coating process.

A wide slot nuzzle can also be used, but the application point for the polymer composition is directly at the nozzle opening. Thus, the polymer composition is confined between the front face and the fiber for some time or distance.

The nozzle adapted to dispense polymer composition, and in particular a wide slot nozzle, curtain coater or roll coater, are adapted to dispense the molten polymer composition in the direction of gravity (e.g. immediately before it hits the uncoated filament).

By specifying the angle or the essentially parallelism, undesirable forces (shear forces, turbulence due to changes in direction of the polymer composition) are reduced so that rapid wetting of the filament can take place.

The polymer composition may contain an adhesion promoter that improves adhesion between the inorganic filament and the polymer composition. Therefore, the polymer composition may comprise an adhesion promoter.

Surprisingly, in the process of the invention, when using an adhesion promoter, sizing of the inorganic fiber is not needed.

The polymer composition can be melted by a suitable heating device (e.g. a (single ortwin screw) extruder).

The coating device can also comprise a reservoir for the polymer composition comprising an adhesion promoter and a reservoir for the polymer composition which does not comprise an adhesion promoter.

In this way, the ratio of the polymer composition comprising an adhesion promoter and a polymer composition not comprising an adhesion promoter can be suitably adapted. The mixing of the polymer composition(s) can occur in an additional mixing device or an extruder as discussed above. The polymers may be provided in solid or fluid form (resulting in dry or wet blending).

Also disclosed is an apparatus for making a filament bundle comprising:
a. a nozzle configured to produce an uncoated inorganic filament from an inorganic melt;
b. a coating device as described above;
C. a fiber bundling device configured to produce a bundle of coated filaments from the coated filament.

The device for producing a filament bundle does not comprise, between the nozzle arranged to produce an uncoated inorganic filament from an inorganic melt and the coating device, a device for coating the uncoated inorganic filament with, for example, an adhesion promoter.

The apparatus may include a plurality of nozzles for dispensing the uncoated inorganic filament.

However, the device for producing a filament bundle may include devices immediately downstream of the coating device for further modification of the coated filament (e.g., further coating devices, irradiation devices, heating devices, cooling devices, etc.).

The apparatus may also include, downstream of the coating apparatus or optionally further apparatus for further modification of the coated filament, a filament guide and a bobbin for receiving the filament bundle.

### BRIEF DESCRIPTION OF FIGURES

FIG. 1 schematically shows a front view of an apparatus for producing a filament bundle according to the disclosure.

FIG. 2 shows a schematic side view of the device from FIG. 1.

FIG. 3 schematically shows the process of coating the uncoated inorganic filament with polymer composition.

FIG. 4 schematically shows the process of coating the uncoated inorganic filament with polymer composition using a wide slot die.

FIG. 5 schematically shows the process of coating the uncoated inorganic filament with polymer composition using a curtain coater.

FIG. 6 schematically shows the process of coating the uncoated inorganic filament with polymer composition using a roll coater.

### DETAILED DESCRIPTION

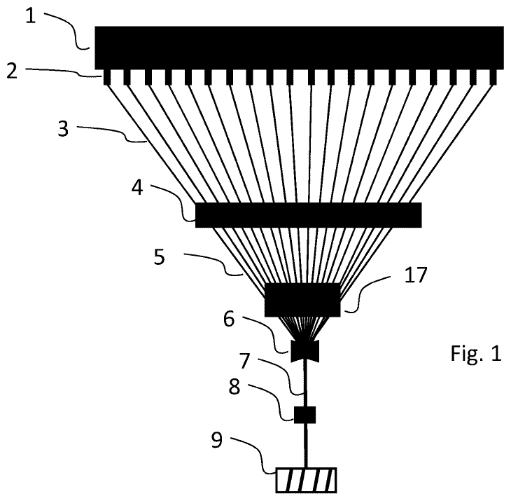

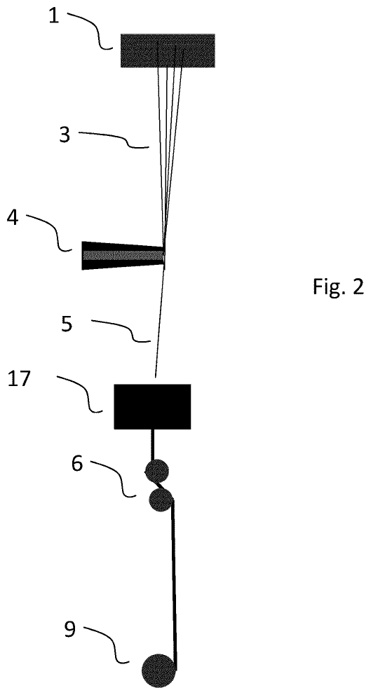

FIGS. 1 and 2 show front and side views of an apparatus for producing a filament bundle according to the disclosure. The same can be used to perform a glass drawing process in accordance with the present disclosure.

Pellets made of an inorganic material (in particular gals) are fed from a storage container melting furnace 1 (bushing). There, the inorganic material is metered and melted. The melt exits through nozzles between cooling fins (not shown) and thus solidifies. The inorganic material forms the core of the filaments of core and polymer composition and in turn is also in the form of filaments. The uncoated inorganic filament 3 is subsequently passed through a coating device for having a nozzle for dispensing fluid polymer composition, for example a molten polymer composition comprising a thermoplastic polymer. The apparatus for producing a filament bundle may further comprise reservoirs of adhesion promoter which, via a conduit, feeds the melted polymer composition to the nozzle of the coating apparatus.

Thereafter, the coated filaments may pass through a modification apparatus 17 (e.g., a sizing apparatus comprising a post-sizing roller and a sizing trough for applying an additional aqueous solution, such as a sizing or a coating, preferably a silane-containing solution. Subsequently, a filament bundle can be manufactured from the individual filaments in the assembly device 6. This runs through a yarn guide 8 to a bobbin 9, where the fiber is wound up and made available for further processing.

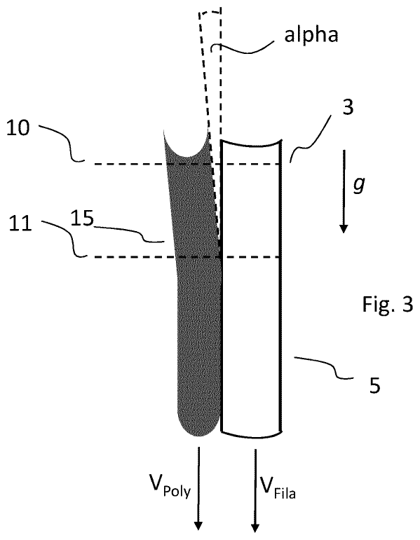

FIG. 3 schematically shows the process of coating the uncoated inorganic filament 3 with polymer composition 15 in the coating apparatus in side view.

The uncoated inorganic filament 3 is fed in the direction of gravity g from top to bottom through the coating device. It thereby exhibits a velocity V_{Fila}. The molten polymer composition 15 (e.g., comprising an adhesion promoter) is guided substantially parallel to the inorganic filament 3. This is achieved by using a nozzle for dispensing (e.g., 12, 13, 14), which ultimately dispenses the molten polymer composition 15 also in the direction of gravity. The point at which the polymer composition is applied to the filament is the application point 10. However, wetting does not yet take place at this point, since the wetting process takes a certain amount of time. The point at which the polymer composition 15 wets the filament 3, i.e. comes into direct contact, is the point at which wetting 11 begins. After wetting begins, the surface tension of the polymer composition causes it to spread all around the filament. Depending on the amount of polymer composition dispensed and/or the viscosity properties of the polymer composition, it is possible that a speckle coating or sheath coating of the polymer composition may appear on the filament.

The angle alpha between the application point and the point of the beginning of wetting, the legs of which are a straight line imaginary through the filament and one directly opposite to the filament through the surface of the polymer composition can be between 0° and 25°, 0° and 10°, or 0° and 1°.

The polymer composition 15 moves in the direction of gravity with velocity V_{poly}. V_{Poly} and V_{Fila} have essentially the same amounts, so there are no undesirable forces or effects between polymer composition on filament.

FIG. 4 schematically shows the process of coating the uncoated inorganic filament with polymer composition 15 using a wide slot die 12.

In a wide slot die 12 as defined in this disclosure, the polymer composition 15 is dispensed through a horizontal channel and flows down vertically due to gravity. The wide slot nozzle 12 is arranged so that when the polymer composition is dispensed, the vertically draining polymer composition meets the filament, with the vertically draining polymer composition and filament having substantially the same velocity.

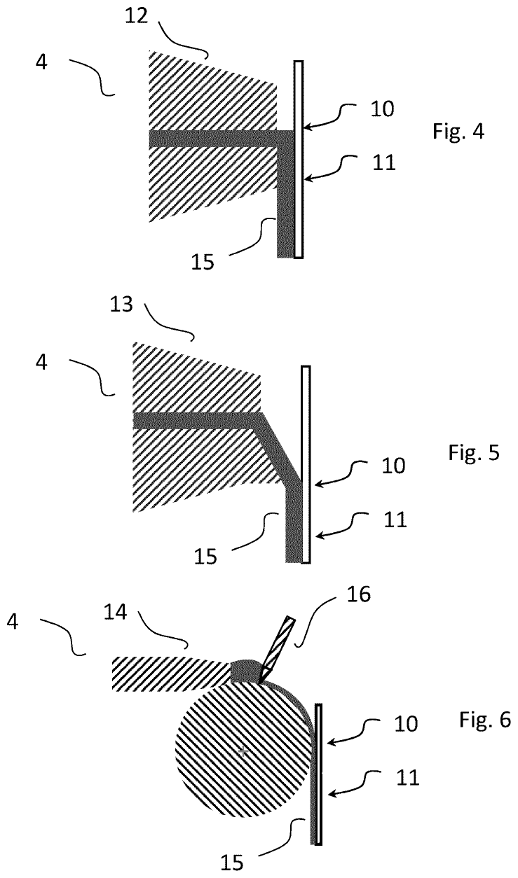

FIG. 5 schematically shows the process of coating the uncoated inorganic filament 3 with polymer composition 15 using a curtain coater 13.

In a curtain coater 13 as defined in this disclosure, the polymer composition 15 is dispensed through a horizontal channel, flows over a lip due to gravity, and then drains vertically. In a curtain coater 13 as defined in this disclosure, the polymer composition 15 is dispensed through a horizontal channel, flows over a lip due to gravity, and then drains vertically. A curtain coater as described here has the advantage that no pressure from the polymer composition is applied to the filament, which prevents fiber breaks at high speeds.

FIG. 6 schematically shows the process of coating the uncoated inorganic filament with polymer composition using a roll coater 14.

In a roll coater 14 as defined in the present disclosure, the polymer composition 15 is dispensed through a horizontal channel and passes over the top of a roll. By rotating the roller, the polymer composition flows over the roller in the direction of this filament. Due to gravity, the polymer composition flows off vertically. The roll coater 14 is arranged so that when the polymer composition is dispensed, the vertically draining polymer composition impinges on the filament, the vertically draining polymer composition and filament having substantially the same velocity. A blade 16 spaced on the roller between the discharge channel and the point of vertical discharge of polymer composition 15 and the tip to the roller can regulate the amount of polymer composition 15 discharged. A roll coater, as described here, has the advantage that no pressure from the polymer composition is applied to the filament, which prevents fiber breakage at high speeds.

### Screening Experiments to Identify Suitable Thermoplastic Polymers

Samples of polymer compositions were prepared from the components of Table 1 as follows: If all components are solid, powder blends were made by mixing the powders in a plastic bag, polymers in pellet shape were powdered by cryogenic grinding. In case of liquid additives, the additive was dissolved in an appropriate solvent, spread out over powdered polypropylene (PP) and the solvent was allowed to evaporate overnight in a fume hood after which the powder with additive was mixed well by shaking in a plastic bag.

The so formed mixture was added by means of a loss-in-weight feeder at 300 g/h to a Thermo Scientific Process 11 (P11) 11 mm diameter, twin-screw, corotating extruder twin screw extruder with an L/D of 45 having as crew built up with transportation elements and 3 sections of kneeding elements at a speed of 250 rpm and the barrel having 8 heating sections set at 40, 120, 180, 200, 200, 200 and 200° C., the die set at 200° C. The extrudate was cooled in a water bath with running tap water and pelletized.

### IFSS Measurement (Interfacial Shear Strength)

Samples of coated glass filaments were prepared from the pellets and the interfacial shear strength was determined by the Microbond test described in L. Yang & J. L. Thomason: Development and application of micromechanical techniques for characterising interfacial shear strength (IFSS) in fibre-thermoplastic composites-Polymer Testing 31 (2012) 895-903). The pellets of the composition obtained above were molten and a filament was drawn from the melt. A loose knot was made from the filament and one glass filament was placed in the loose knot. The knot was tightened and excess of the PP filament was cut away, resulting in a small knot of PP filament around the glass filament. This was heated under nitrogen to melt the PP composition, forming a droplet of the PP composition around the filament. After cooling, the droplet was solidified. The glass filament was pulled out to determine the interfacial shear strength.

In CE1, the polymer composition was applied to glass filaments provided with an aminosilane sizing composition optimized for adhesion to PP. In CE2-CE4, E5, RE6-RE7, E8-E19, the polymer composition was applied to glass filaments without any sizing composition, supplied by Fibrecoat GmbH.

### Materials:

### A)

C1) type MAH: Exxelor PO1020 from Exxon Mobil, polypropylene grafted with maleic anhydride (0.9 wt % anhydride)
C1) type ITA: Scona TSPP 8219 GA from BYK Chemie GmbH, polypropylene grafted with itaconic anhydride (2 wt % anhydride)
C1) type epoxy: Scona TPPP 8104 FA from Chemie GmbH, polypropylene grafted with glycidyl methacrylate (2.5 wt % glycidyl methacrylate)

### B)

PP595A from SABIC, propylene homopolymer having MFR according to ISO1133 at 230° C. and 2.16 kg of 47 dg/min

### C2)

PA: Radipol S24HA from Radicii Group, polyamide 6
PE-HEMA: poly(ethylene-hydroxyethylmethacrylate) containing 12 wt % of hydroxyethylmethacrylate
vinyl-oligosilane: Silquest G-170 from Momentive Performance Materials
aminopropyl-oligosilane: Silquest VX-225 from Momentive Performance Materials
acryloxy-oligosilane: Silquest A-274 from Momentive Performance Materials
titanate pyrophosphate: Ken-React LICA 38 from Kenrich Petrochemicals, Inc., neopentyl(diallyl) oxy tri (dioctyl) pyrophosphate titanate

The compounds mentioned above as C2) have a hydrogen atom capable of forming hydrogen bond or have a functional group which generates a hydrogen atom by (partial) hydrolyzation of the group.

### Others

EVA: poly(ethylene-vinylacetate) containing 10 wt % of vinylacetate zirconate phosphate: Ken-React ZN 12 from Kenrich Petrochemicals, Inc., isooctanol hydrogen phosphate zirconium complex

The compounds mentioned above as Others do not have a hydrogen atom capable of forming hydrogen bond and do not have a functional group which generates a hydrogen atom by (partial) hydrolyzation of the group.

### Other Measurement Methods

### Melt Viscosity

Melt viscosity was measured in accordance with ISO6721-10:2015 on either pellets or extruded pieces that are inserted in the plate-plate oscillatory-shear rheometer. A MCR 502 rotational rheometer from AntonPaar was used. The sample was molten inside the 25 mm diameter test-geometry at the measurement temperature (oven set to 250° C. or 290° C.) and the sample was preheated in the oven for 1 minute to obtain a completely molten sample and trimmed to a 1 mm gap, after which oscillating-shear was applied with an Angular Frequency of 1 rad/s and shear strain of 5%. During this test the melt viscosity was monitored as a function of time.

Standard linear propylene homopolymers (with different melt flow rates) were used to calibrate the rheometer.

### Melting Temperature

The melting temperature is determined by differential scanning calorimetry using the second heating curve, wherein the first heating rate is 10° C./min, the first cooling rate is 10° C./min, the second heating rate is 10° C./min, and the sample weight is 5 mg.

In CE1, the glass filaments with the sizing composition coated with a composition comprising polypropylene grafted with maleic anhydride resulted in a high IFSS.

CE2 shows that application of polypropylene to glass filaments without sizing composition results in a low IFSS, lower than 10 MPa.

Comparison of CE3 to CE4 versus CE2 shows that the use of compounds that do not have a hydrogen atom capable of forming hydrogen bond and do not have a functional group which generates a hydrogen atom by (partial) hydrolyzation of the group still results in a low IFSS, lower than 10 MPa.

Comparison of E5, RE6, RE7 and E8 to E19 versus CE2 shows that the use of compounds that have a hydrogen atom capable of forming hydrogen bond or have a functional group which generates a hydrogen atom by (partial) hydrolyzation of the group results in a high IFSS, exceeding 10 MPa.

TABLE 1

| | A) | | B) | | C2 | | IFSS |
|---|---|---|---|---|---|---|---|
| | (wt %) | C1) type | (wt %) | C2) type | (wt %) | Others | [MPa] |
| CE1 | 3 | MAH | 97 | | | | 23 |
| CE2 | | | 100 | | | | 7.1 |
| CE3 | | | | | | EVA | 6.3 |
| | | | | | | (100 | |
| | | | | | | wt %) | |
| CE4 | | | 99 | | | zirconate | 8.6 |
| | | | | | | phosphate | |
| | | | | | | (1 wt %) | |
| E5 | 100 | MAH | | | | | 25.3 |
| RE6 | | | | PA | 100 | | 12.6 |
| RE7 | | | | PE-HEMA | 100 | | 10.2 |
| E8 | | | 92 | vinyl-oli- | 8 | | 15 |
| | | | | gosilane | | | |
| E9 | | | 99 | titanate pyro- | 1 | | 13 |
| | | | | phosphate | | | |
| E10 | | | 96 | vinyl-oli- | 4 | | 14.2 |
| | | | | gosilane | | | |
| E11 | 100 | ITA | | | | | 24.5 |
| E12 | 100 | epoxy | | | | | 11.8 |
| E13 | 3 | MAH | 97 | | | | 15 |
| E14 | 10 | MAH | 90 | | | | 14.9 |
| E15 | 20 | MAH | 80 | | | | 16.8 |
| E16 | 3 | MAH | 96 | titanate poly- | 1 | | 20.2 |
| | | | | phosphate | | | |
| E17 | 3 | MAH | 93 | vinyl-oli- | 4 | | 13.3 |
| | | | | gosilane | | | |
| E18 | 3 | MAH | 93 | aminopropyl- | 4 | | 10.5 |
| | | | | oligosilane | | | |
| E19 | | | 96 | acryloxy-oli- | 4 | | 11.4 |
| | | | | gosilane | | | |

ILSS of bare glass filaments to pure anhydride grafted PP is very high (E5 and E11), even exceeding that of sized glass filaments with PP/PP-g-MAH 97/3 resin (CE1). Diluting PP-g-MAH in PP homopolymer decreases ILSS values (E13-E15), but even dilution to 3 wt % PP-g-MAH (E13) still results in a relatively high ILSS. The effect of epoxy grafted PP is lower than anhydride grafted PP (E12 versus E4 and E11).

The addition of an oligosilane to PP results in a high ILSS (E8 and E10 versus CE2). When comparing different types of oligosilanes, aminopropyl-oligosilane in combination with PPMAH (E18) has the lowest effect. The acryloxy-oligosilane (E19) has a slightly higher effect and the vinyl-oligosilane (E10) has a considerably higher effect. Increasing the vinyl-oligosilane level to 8 wt % resulted in a slight increase (E8).

The addition of both oligosilane and a grafted PPMAH to PP does not have a large effect in ILSS. The addition of both results in a lower ILSS than the addition of either of the two separately (E17 versus E10, E17 versus E13).

The addition of a titanate pyrophosphate results in a high ILSS (E9 versus CE2). The addition of both titanate pyrophosphate and a grafted PPMAH to PP results in a large increase in ILSS. The addition of both results in a higher ILSS than the addition of either of the two separately (E16 versus E9, E16 versus E13).

Specific interactions via alcohol or amine/amide groups lead to higher values of ILSS, but still on the low end of all samples tested, RE6 and RE7.

Compositions were prepared as described below for application on just spun glass filaments.

### Composition Set 1: Blends

Several blends of SABIC® 514M12 and SABIC® PP595A were made by extrusion in an ESDE 35 mm 27 L/D single screw extruder, type ESE 1-35-27 with temperature settings of the barrel at 150, 240, 290, 290 and 290° C. The extruder was feeding a melt pump and slit die. The melt filter, melt pump, pipe to the die and die temperatures were all set at 290° C. The viscosity was measured also at 290° C. In table 1 the correlation between the content of SABIC® 514M12 material and the melt viscosity are shown.

TABLE 1
viscosity of extruded SABIC ® 514M12/PP595A blends.

| | Weight ratio | | | |
|---|---|---|---|---|
| Sample | SABIC ® | Pressure | | viscosity [Pa · s] |
| nr | 514M12/595A | [bar] | Temp | at 290° C. |
| 1 | 100/0 | 50 | 290 | 1.8 |
| 2 | 75/25 | 50 | 290 | 2.6 |
| 3 | 50/50 | 50 | 290 | 3.4 |
| 4 | 25/75 | 50 | 290 | 5.7 |
| 5 | 0/100 | 50 | 290 | 19.4 |

### Composition Set 2: Visbroken PP595A

Visbreaking was carried out on a Krauss-Maffei-Berstorff ZE25A 25 mm corotating twin screw extruder with 48 L/D. The screw is composed of transport elements with kneading sections. The barrel has 11 sections with set temperatures of 40, 120, 160, 190, 190, 190, 190, 190, 190, 190 and 190° C., the die temperature was also set at 190° C. PP595A pellets were fed by means of a loss-in-weight feeder. The peroxide mixture was dissolved in Linpar 10-13 oil and fed to the extruder at barrel 4 by means of a liquid pump. The amounts of the peroxides and the active oxygen are shown in Table 2. The extrudate was cooled in a water bath with running tap water and pelletized. Melt viscosity was measured at 250° C.

TABLE 2
melt viscosity of PP at 250° C. as a function of active oxygen.

| | | 6 | 7 |
|---|---|---|---|
| T101 | [ppm] | 0 | 1200 |
| T301 | [ppm] | 0 | 1000 |
| Active Oxygen | [ppm] | 0 | 196 |
| Viscosity at 250° C. | [Pa · s] | 198.6 | 20 |

TABLE 3
melt viscosity of PP at 250° C. as a function of active oxygen.

| | | 8 | 9 | 10 |
|---|---|---|---|---|
| T101 | [ppm] | 0 | 1200 | 1200 |
| T301 | [ppm] | 0 | 3000 | 6000 |
| Active Oxygen | [ppm] | 0 | 344 | 566 |
| Viscosity at 250° C. | [Pa · s] | 173 | 6.6 | 3.1 |

### Composition Set 3: Visbroken PP595A

Visbreaking was carried out on larger scale, using peroxide master batches on a Krauss-Maffei-Berstorff ZE40A-UTX 40 mm corotating twin screw extruder with 43 L/D. The screw is composed of transport elements with 3 kneading sections. The peroxides were added as 20 wt % master batches together with PP595A pellets. The temperature profile set points were 20, 20, 30, 50 100, 150, 230, 230, 230, 230, 235, 260 and 260° C. The samples were extruded at 175 rpm and 100 kg/h. The amounts of the peroxides and the active oxygen are shown in Table 3. Melt viscosity was measured at 250° C.

The active oxygen content of the formulations is calculated based on the concentration of peroxide and the active oxygen content of the peroxide as can be found in the technical data sheet of the supplier.

E.g. Sample 7 contains 1200 ppm Trigonox 101 and 1000 ppm Trigonox 301. The active oxygen content of Trigonox 101 is 10.14% and of Trigonox 301 is 7.4%, therefore the active oxygen content of this sample is calculated to be 196 ppm.

### LIST OF REFERENCE SIGNS

1 Bushing (melting furnace)
2 Nozzle
3 Inorganic uncoated filament
4 Coating device
5 Coated inorganic filament
6 Assembly device
7 Filament bundle
8 Thread guide
9 Coil
10 Line/point of initial contact
11 Line/point of the beginning of wetting
12 Wide slot nozzle
13 Curtain coater
14 Roll Coater
15 Polymer composition
16 Knife
17 Modification device
Alpha Angle between polymer composition and inorganic filament between wetting point and initial contact point.
V_{Poly} Velocity and direction of the molten polymer composition output.
V_{Fila} Speed and direction of the output inorganic filament.

1. A coated filament comprising an inorganic filament and a polymer composition comprising a thermoplastic polymer, wherein the polymer composition is in direct contact with the filament and wherein the coated filament has a length of less than 100 mm.

2. The coated filament according to claim 1, wherein the polymer composition comprises at least 95 wt % of the thermoplastic polymer based on the polymer composition and/or wherein the thermoplastic polymer is chosen from the group of acrylonitrile butadiene styrene (ABS), acrylonitrile styrene acrylate (ASA), polyethylene (PE), polyolefin elastomer (POE), polyethylene terephthalate (PET), polypropylene (PP), polyvinylchloride (PVC), polybutadiene (BR), ethylene propylene diene monomer (EPDM, polyamide (PA), thermoplastic polyurethane (TPU) and mixtures thereof.

3. The coated filament according to claim 1, wherein the polymer composition comprises a polypropylene composition comprising A) a grafted polypropylene grafted with C1) a side chain compound capable of forming hydrogen bond and/or
B) a non-grafted polypropylene and C2) a compound capable of forming hydrogen bond, wherein the total amount of A) and B) with respect to the polypropylene composition is at least 70 wt % and the polypropylene composition comprises D) a low molecular weight polyethylene having molecular weight of at most 5000 g/mol in an amount of less than 10 wt % with respect to the polypropylene composition.

4. The coated filament according to claim 1, wherein the polymer composition has a melt viscosity in the range from 1.0 to 25 Pas at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%.

5. The coated filament according to claim 4, wherein the polymer composition meets inequation 1:
$$η \leq ( 82 \times e \hat{} 0.007 \times ( ACTO ) ) + 5 \qquad ( inequation 1 )$$
wherein η stands for the melt viscosity in Pa·s as measured at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5% and wherein ACTO stands for the amount of active oxygen in the polymer composition in ppm.

6. The coated filament according to claim 1, wherein the coating is a spot coating or a mantle coating.

7. A filament bundle comprising a plurality of coated filaments according to claim 1.

8. An article comprising the coated filament of claim 1.

9. A coated filament, filament bundle or tape obtainable by a method for producing a coated filament comprising the steps of
a. producing an uncoated inorganic filament from an inorganic melt;
b. providing a molten polymer composition comprising a thermoplastic polymer;
c. applying the molten polymer composition to the uncoated inorganic filament and allowing the molten polymer composition to solidify and
d. obtaining a coated filament comprising an inorganic filament which is coated with the polymer composition and wherein the inorganic filament is in direct contact with the polymer composition and
e1. cutting the coated filament into pieces having a length of less than 100 mm or
e2 bundling a plurality of said coated filaments into a filamentbundle or a yarn and optionally cutting the filament bundle or yarn into pieces having a length of less than 100 mm or
f. bundling a plurality of said coated filaments into a filamentbundle or a yarn and
g. producing a tape from the filamentbundle or from the yarn to produce a tape having a thickness from 0.2 up to and including 2 mm, a width from 10 up to and including 500 mm and wherein the tape has a length/width ratio of above 10.

10. The coated filament according to claim 9, wherein the polymer composition has a melt viscosity in the range from 1.0 to 25 Pas at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%.

11. The coated filament according to claim 10, wherein the polymer composition meets inequation 1:
$$η \leq ( 82 \times e \hat{} 0.007 \times ( ACTO ) ) + 5 \qquad ( inequation 1 )$$
wherein η stands for the melt viscosity in Pa·s as measured at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5% and wherein ACTO stands for the amount of active oxygen in the polymer composition in ppm.

12. The coated filament according to claim 9, wherein during the application step the polymer composition contacts the uncoated inorganic filament at an angle of at most 45°.

13. The coated filament according to claim 9, wherein when applying the organic polymer to the uncoated inorganic filament, the speed at which the polymer is applied is 50% to 110% the speed at which the inorganic filament is moved and/or the speed at which the inorganic filament is moved is 500 to 3000 m/min.

14. The coated filament according to claim 9, wherein the polymer composition is molten using a melting device.
